(19) United States
(12) Patent Application Publication
(10) Pub. No.: US 2025/0309647 A1
(43) Pub. Date: Oct. 2, 2025

(54) APPARATUSES, SYSTEMS, AND METHODS FOR IMPROVING POWER MANAGEMENT IN PROCESSORS VIA ARTIFICIAL NEURAL NETWORKS

(71) Applicant: ATI Technologies ULC, Markham (CA)

(72) Inventor: Danial Yahyazadeh, Markham (CA)

(73) Assignee: ATI Technologies ULC, Markham (CA)

(21) Appl. No.: 18/617,501

(22) Filed: Mar. 26, 2024

(51) Int. Cl. H02J 3/00

(52) U.S. Cl. CPC H02J 3/003; H02J 2203/20

(57) ABSTRACT

A disclosed power management integrated circuit includes (1) a voltage source electrically coupled to a voltage output of a portion of a processing unit, (2) a prediction circuit electrically coupled to the voltage source, the prediction circuit comprising an artificial neural network (ANN) model trained to predict an inductor current based on a voltage received via the voltage source, and a management circuit configured to manage power usage of the processing unit based on a predicted inductor current received from the prediction circuit, the predicted inductor current predicted via the ANN model based on the voltage received via the voltage source. Various other apparatuses, systems, and methods for improving processor power management via ANNs are also disclosed.

### BACKGROUND

Electronic devices, especially those with high computational needs such as graphics processing units (GPUs), typically use static control schemes and intricate hardware for power management.

### BRIEF DESCRIPTION OF THE DRAWINGS

The accompanying drawings illustrate a number of examples and variations and are a part of the specification. Together with the following description, these drawings demonstrate and explain various principles of the instant disclosure.

FIG. 1 shows a block diagram of an example power management integrated circuit that can improve power management in a processor via an artificial neural network (ANN) model in accordance with some examples described herein.

FIG. 2 shows a block diagram of an example system for training an ANN in accordance with some examples described herein.

FIG. 3 shows a flow diagram of an example method for training an ANN to improve power management in processors in accordance with some examples described herein.

FIG. 4 and FIG. 5 show block diagrams of example systems for improving power management in processors via ANNs in accordance with some examples described herein.

FIG. 6 shows a diagram of a recurrent artificial neural network (RNN) in accordance with some examples described herein.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the examples described herein are not intended to be limited to the particular forms disclosed. Rather, the instant disclosure covers all modifications, equivalents, and alternatives falling within the scope of the appended claims.

### DETAILED DESCRIPTION OF EXAMPLE IMPLEMENTATIONS

Conventional processor power management systems, applicable to a variety of processing units such as central processing units (CPUs), GPUs, accelerated processing units (APUs), and tensor processing units (TPUs), typically utilize various sensors and controllers to manage power usage based on predetermined thresholds and operational states. These systems, while functional across different types of processing units, often lack the flexibility to adapt to dynamic operational conditions and may not efficiently handle rapid fluctuations in power requirements due to their predefined nature.

Furthermore, existing power management solutions may involve complex circuitry, including multiple sensors and analog-to-digital converters (ADCs), which can increase the cost, size, and energy consumption of the power management system itself. This is particularly pertinent as processing units become more advanced, with increased core counts and higher operating frequencies, necessitating more sophisticated power management strategies.

There is, therefore, a need for an improved approach to power management in processing units, one that can predict and adapt to varying power demands with greater accuracy and reduced hardware complexity. The integration of machine learning techniques, and in particular, the use of ANNs, offers a promising avenue for achieving these goals. Such intelligent systems are expected to provide more granular control over power distribution, thereby enhancing the overall efficiency and performance of electronic devices.

Described herein are apparatuses, systems, and methods for improving processor power management via ANN models trained to predict a processor's future power needs based on electrical power usage data. This approach is particularly effective in predicting the computational demand of processing units, which is electrically manifested in load currents, through the prediction of inductor or Power Distribution Network (also a Power Delivery Network or PDN) currents. These currents serve as early indicators of the processing unit's future computational demands, enabling power management systems to act preemptively. By way of example, an implementation of the apparatuses, systems, and methods disclosed herein may gather and/or receive voltage data and/or electrical current data associated with at least a portion of a processing unit. The voltage data and electrical current data can correspond to a concurrent period of time. The implementation may analyze this data to train an ANN model to predict an electrical current value, such as Inductor or PDN current, based on an input voltage, thereby providing insight into future computational loads. Once the ANN model is trained, an implementation may provide the trained ANN for use in power management of the processing unit and/or additional processing units.

In some examples, the ANN can include an RNN. An RNN is a type of ANN designed to recognize patterns in sequences of data, such as time series. Unlike standard feedforward neural networks, RNNs make use of an internal memory to process sequences of inputs. This makes them well suited for tasks where context and the order of data points are important, such as in power management applications where past power usage can influence future requirements, across various processing unit architectures.

As will be described in greater detail below, RNNs can be trained on historical electrical voltage and electrical current data collected from a processing unit. This data can include time-stamped measurements that reflect the processing unit's power consumption over time. By learning from this data, the RNN can understand how power usage changes in response to different operational conditions.

Once trained, the RNN can predict future power demands based on present and past data. For instance, it can estimate the inductor current—the current flowing through the inductors in a PDN of a processing unit—by analyzing the voltage data it receives. These predictions can be valuable because they can inform a power management unit about how much power will likely be needed in the near future.

By anticipating power needs, the RNN can enable a power management unit (e.g., a power management integrated circuit, or “PMIC”) to make proactive adjustments to the power supply. This could involve increasing or decreasing the voltage, modulating the frequency of power delivery, or switching between different power modes to optimize performance and energy efficiency.

Examples of the apparatuses, systems, and methods disclosed herein may provide several benefits, such as reduced energy consumption, enhanced processing performance by ensuring that the processing unit has the power it needs when it needs it, improved battery life in portable devices by minimizing unnecessary power usage, and reduced risk of overheating and hardware damage by preventing power spikes.

Implementations of the apparatuses, systems, and methods disclosed herein may also offer a significant advantage over conventional power management solutions by optimizing power management without necessitating additional hardware components. By utilizing an ANN, in some examples an RNN, implementations may intelligently predict power demands based on existing voltage and current data across different processor architectures. This predictive capability can be embedded within the existing power management framework of the processing unit, leveraging data already available via the power management infrastructure. As a result, there is no requirement for new sensors or circuits to be added to the processing unit's architecture. This integration minimizes the physical footprint and cost associated with extra hardware, simplifies the design and manufacturing process, and maintains the processing unit's energy efficiency by reducing the power consumption that would be required to support additional components.

In one example, a power management integrated circuit includes a voltage source electrically coupled to a voltage output of a portion of a processing unit. The power management integrated circuit can also include a prediction circuit electrically coupled to the voltage source, and the prediction circuit can include an ANN model trained to predict an inductor current based on a voltage received via the voltage source. The power management integrated circuit can also include a management circuit configured to manage power usage of the processing unit based on a predicted inductor current received from the prediction circuit, the predicted inductor current predicted via the ANN model based on the voltage received via the voltage source.

Another example can be the power management integrated circuit of the previously described example power management integrated circuits, wherein (1) the ANN model includes an RNN, and (2) the RNN is pre-trained in accordance with an RNN training process. The RNN training process can include (1) initializing a plurality of weight values of the RNN with random values, (2) executing a training iteration that includes (a) inputting sequences of observed voltage data points and current data points into the RNN, (b) generating predicted current values, (c) calculating a loss by comparing the predicted current values with actual measured current values, and (d) updating at least one of the plurality weight values using backpropagation through time and an optimization algorithm. The RNN training process can further include repeating the training iteration until a predetermined convergence criterion is met, and validating the RNN with a set of validation data.

Another example can include any of the previously described example power management integrated circuits, wherein the processing unit is or includes at least one of at least one of (1) a central processing unit (CPU), (2) a GPU, a tensor processing unit (TPU), or (4) an accelerated processing unit (APU). Another example can include the previously described example power management integrated circuit, wherein the ANN model is incorporated into an artificial intelligence core of the processing unit.

In an additional example, an example method includes receiving (1) voltage data representative of a measured voltage associated with at least a portion of a processing unit, and (2) electrical current data representative of a measured current associated with the portion of the processing unit, the voltage data and current data both corresponding to a concurrent period of time. The example method can also include training an artificial neural network (ANN) model to predict an electrical current value based on an input voltage by directing the ANN model to analyze the received voltage data and the received current data in accordance with a training process of the ANN model, and providing the trained ANN model for use in power management of the processing unit.

Another example can be the previously described example method, wherein the ANN model includes an RNN. Another example can be the previously described example method, wherein (1) the RNN includes a plurality of weight values and (2) the training process of the ANN model includes (a) initializing the plurality of weight values of the RNN with random values, (b) executing a training iteration that includes (i) inputting a sequence of voltage data points and current data points into the RNN, (ii) generating predicted current values, (iii) calculating a loss by comparing predicted values with measured current values, and (iv) updating at least one of the plurality of weight values using backpropagation through time (BPTT) and an optimization algorithm, (c) repeating the training iteration until a predetermined convergence criterion is met, and (3) validating the RNN with a set of validation data.

Another example can be any of the previously described example methods, wherein the processing unit includes a GPU. In some examples, providing the trained ANN model for use in power management of the processing unit includes incorporating the trained ANN model into an artificial intelligence core of the GPU.

Another example can include any of the previously described example methods, wherein the voltage data includes waveform data indicative of a dynamic response of a direct-current-to-direct-current converter under a plurality of load conditions.

Another example can include any of the previously described example methods, wherein training the ANN model includes analyzing voltage waveform data that reflects dynamic voltage regulator responses due to emulated current loads on a PDN, the dynamic voltage regulator responses including at least one of (1) a voltage overshoot, (2) a voltage undershoot, (3) a voltage load line, (4) a voltage slew rate, and (5) a settling time.

Another example can be the previously described example method, wherein the emulated current loads include at least one of (1) a direct current (DC) load with amplitudes ranging between a minimum and a maximum of a thermal design current of the processing unit, and (2) an alternating current (AC) load with amplitudes ranging between a minimum and a maximum of an electrical design current of the processing unit. In some examples, the emulated current loads include the AC load with amplitudes ranging between the minimum and the maximum of the electrical design current of the processing unit, and the AC current load is emulated with pulses at frequencies between 10 kilohertz (kHz) and 100 kHz. In some examples, the emulated current loads include the AC load with amplitudes ranging between the minimum and the maximum of the electrical design current of the processing unit, and the AC current load is emulated with duty cycles that vary to simulate different operational conditions of the processing unit.

Another example can be any of the previously described example methods, further including collecting the electrical current data via at least one sensing element electrically coupled to a PDN included in the processing unit.

Another example can be any of the previously described example methods, further including collecting the electrical current data by aggregating a plurality of electrical current data sources collected via a plurality of sensing elements electrically coupled to a plurality of inductors included in the processing unit.

Another example can be any of the previously described example methods, further including providing the trained ANN model for use in power management of an additional processing unit.

In another variation, an example system can include (1) at least one processor, and (2) at least one storage medium having encoded thereon executable instructions that, when executed by the at least one processor, cause the at least one processor to carry out a method, the method including (a) receiving (i) voltage data representative of a measured voltage associated with at least a portion of a processing unit, and (ii) electrical current data representative of a measured current associated with the portion of the processing unit, wherein the voltage data and current data correspond to a concurrent period of time, (b) training an ANN model to predict an electrical current value based on input voltage data by analyzing the received voltage data and the received current data, and (c) providing the ANN model for use in power management of an additional processing unit.

Another example can be the previously described example system, wherein (1) the ANN model is an RNN, and (2) training the ANN model includes (a) initializing a plurality of weight values of the RNN with random values, (b) executing a training iteration that includes: (i) inputting sequences of voltage data points and current data points into the RNN, (ii) generating predicted current values, (iii) calculating a loss by comparing the predicted values with actual measured current values, and (iv) updating at least one of the weight values using backpropagation through time and an optimization algorithm, (c) repeating the training iteration until a predetermined convergence criterion is met, and (d) validating the RNN with a set of validation data.

Another example can be any of the previously described example systems, further including a data collection interface that includes at least one sensing element electrically coupled to an electrical current sensing point included in the processing unit for collecting the current data.

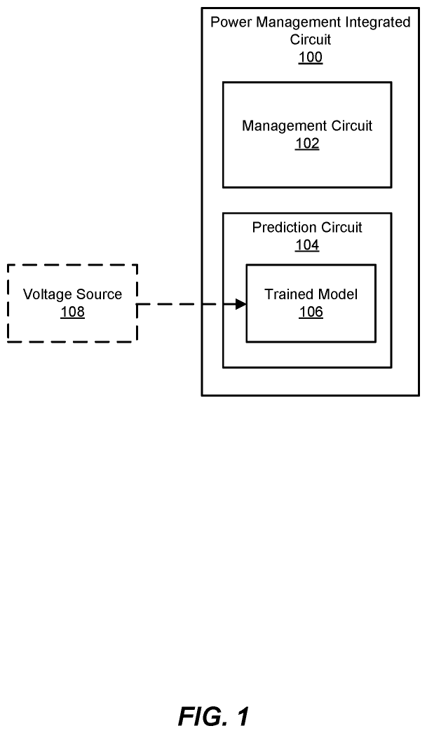

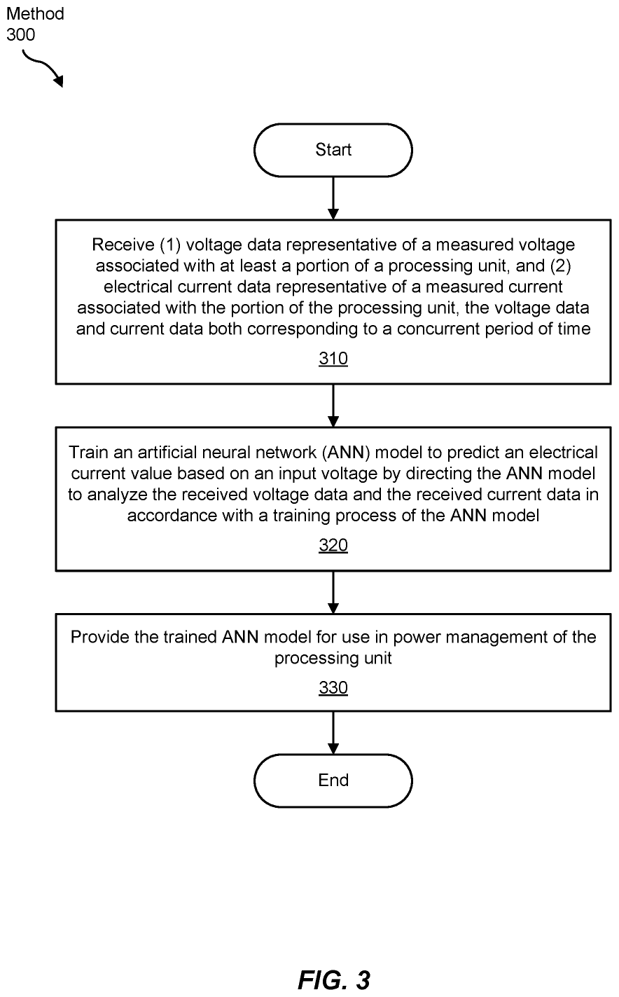

The following will describe, in relation to FIGS. 1-2 and FIGS. 4-6, various different aspects of example apparatuses and systems for improving power management in processors via trained ANNs. Additionally, FIG. 3 shows a flowchart illustrating a method for improving power management in processors via trained ANNs.

FIG. 1 depicts a block diagram of a power management integrated circuit (PMIC) 100 designed to improve power management within a processing unit by utilizing the capabilities of an ANN. The PMIC 100 includes a management circuit 102 and a prediction circuit 104, wherein the prediction circuit 104 includes a trained model 106.

The management circuit 102 is configured to effectively manage the power usage of the processing unit, executing power management tasks such as peak current control, clock throttling, fault protection, performance validation, and voltage/frequency (V/F) tuning. The prediction circuit 104 is electrically coupled to a voltage source 108, which is implied to be connected to the voltage output of a portion of the processing unit, not shown in FIG. 1.

Voltage source 108 can provide real-time voltage data to the prediction circuit 104, which can use this data as an input to the trained model 106. The trained model 106 can be an ANN model that has been previously trained to analyze the inductor current associated with the processing unit based on the voltage data received from voltage source 108. By focusing on the inductor current, whose phase leads the processing unit load current, the trained model can predict the computational demand of the processing unit effectively. This prediction facilitates the elimination of traditional current sense circuits, streamlining the power management process, but also offers a predictive advantage in managing computational loads. Consequently, it can contribute to potentially reducing both the physical footprint on the PCB and the associated costs, while enhancing the responsiveness of PMIC to the processing unit's operational needs. In summary, the systems and methods described herein can predict the processing unit's computational demand (represented in terms of electrical current) through predicting either inductor or PDN current.

As shown, the PMIC 100 integrates the prediction of inductor current via the ANN model within the prediction circuit 104, providing the management circuit 102 with the necessary predictive data to make informed power management decisions.

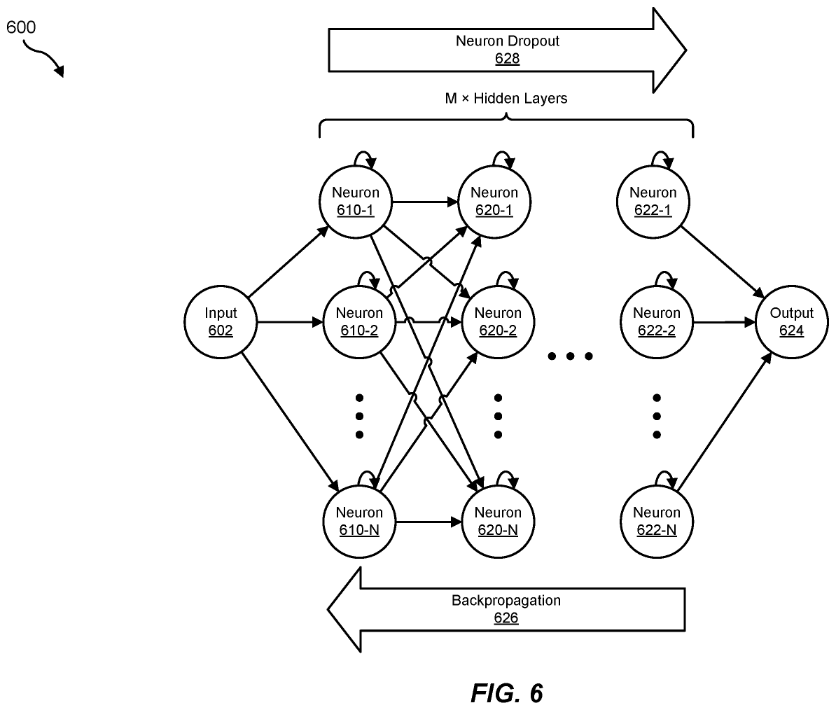

As will be described in greater detail below in reference to FIG. 6, the trained model 106, a specialized example of an ANN, can include or represent a pre-trained RNN. Recurrent neural networks can offer advantages in processing sequences of data-such as voltage readings over time- and can be capable of handling temporal dynamic behavior, which can be helpful for predicting electrical current in real-time scenarios.

The principles associated with the apparatuses, systems, and methods described herein are versatile and adaptable for integration into a variety of processing units, including, but not limited to, CPUs, GPUs, APUs, and/or TPUs. CPUs are often referred to as the brain of the computer. they can perform most of the processing inside a computer and are generally responsible for executing program instructions and managing the operations of other hardware components. CPUs are designed for general-purpose processing and can handle a wide range of computational tasks.

Although originally designed to render graphics in gaming and other visual applications, GPUs have developed into specialized electronic circuits capable of rendering images, animations, and videos. Due to their parallel processing capabilities, GPUs are also used in complex computations beyond graphics, like deep learning and scientific computations.

APUs can include processors that combine a CPU and a GPU on a single chip. They are designed to improve the efficiency and performance of both graphical and computational tasks by allowing these components to work in tandem more effectively.

TPUs can include application-specific integrated circuits (ASICs) developed specifically for machine learning applications. They are optimized for the high-volume computation of operations in neural networks, offering accelerated processing for deep learning tasks.

The ability of the apparatuses, systems, and methods described herein to predict computational demands using an ANN, especially an RNN, and adjust power management strategies accordingly, is applicable across these different types of processing units. Whether integrated within a CPU, GPU, APU, or TPU, the implementations can contribute to more efficient power usage, better performance, and enhanced overall functionality by intelligently adapting to the unique power management needs of each type of processing unit.

Hence, in some examples, the processing unit can be a GPU, CPU, TPU, or APU. In such examples, the voltage source 108 can be representative of the processing unit's voltage output, and the management circuit 102 can be tailored to manage the power requirements of the respective processing unit based on the predictions received from the trained model 106. In some variations, the ANN model, once trained, can be incorporated into an artificial intelligence core of the processing unit. While FIG. 1 does not explicitly show the internal components of a processing unit such as a GPU, CPU, TPU, or APU, it is to be understood that the trained model 106 could be embedded within an artificial intelligence (AI) core of these units to facilitate direct access to power consumption data, thereby integrating power management with the respective processing capabilities.

The PMIC 100 illustrates a novel integration of machine learning models within power management circuits, utilizing existing hardware components and data (e.g., an output voltage, such as from a voltage regulator) to provide new functionalities that traditionally required additional hardware and accompanying costs.

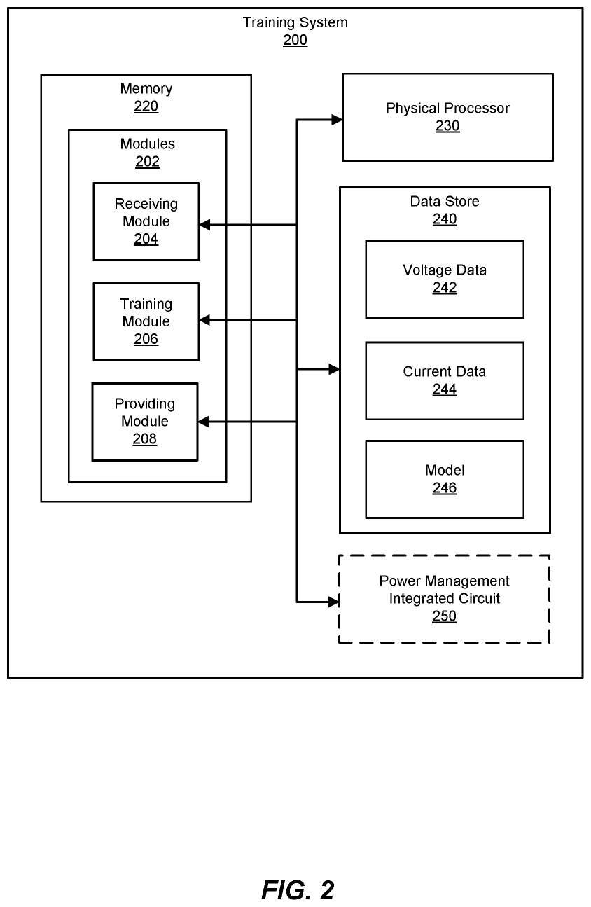

FIG. 2 is a block diagram of a training system 200 for training an ANN to improve power management within a processor. As illustrated in this figure, training system 200 may include a memory 220, a physical processor 230, a data store 240 and, in some examples, can optionally include a PMIC 250. Additionally, training system 200 is depicted to include a collection of functional modules, designated collectively as Modules 202, which are capable of executing a series of operations for the ANN training process. These operations are facilitated through a receiving module 204, a training module 206, and a providing module 208.

Training system 200 is versatile in its implementation. It can be realized in the form of software modules executed on a general-purpose computing device or system, or alternatively, as a hardware device including specialized circuits designed to perform equivalent functions to those of modules 202. In configurations where training system 200 operates on a computing device, the device may include standard components such as at least one memory device and at least one physical processor.

The illustrated modules 202 within memory 220 may represent individual software processes or combined functionality within a single software application. Alternatively, these modules could also manifest as distinct components of an ASIC or a field-programmable gate array (FPGA) where the training system 200 is implemented in hardware.

Memory 220 is a representation of any form of computer-readable medium that stores the operational logic for modules 202. In software-based implementations, memory 220 can include, but is not limited to, Random Access Memory (RAM), Read-Only Memory (ROM), and non-volatile storage devices. In hardware-based implementations, memory 220 may constitute part of a memory component within an ASIC, registers within an FPGA, and so forth.

Physical processor 230, as a part of training system 200, can be interpreted as a general-purpose microprocessor when training system 200 is realized in software, or as a processing unit within a specialized hardware device. This processor is responsible for executing the instructions stored in memory 220, whether those instructions are for general computing or specialized processing related to ANN training.

Data store 240, serving as a databank for voltage data 242 and current data 244, may be implemented within a data store system in a software-based implementation or as memory blocks in a hardware implementation. Additionally or alternatively, voltage data and/or current data may be gathered directly from sensors configured to measure voltage and/or current and translate measured values into data. Model 246, which can reside within data store 240, can represent the ANN to be trained including, without limitation, weight values, neurons, layers, and so forth.

Whether realized through software or hardware, modules 202 work in concert with the physical processor 230 and data store 240 to execute the training process. The receiving module 204 collects input data, the training module 206 processes this data to train model 246, and the providing module 208 oversees the deployment of the trained model 246 for power management tasks, which may include integration with an optional PMIC 250.

In summary, training system 200 can be instantiated as software running on a computing device, leveraging the flexibility of software for easy updates and versatility, and/or as a hardware device with specialized circuits, optimized for speed and efficiency in performing the operations of modules 202. Moreover, in some examples, some components of training system 200 can be implemented in hardware while others can be implemented in software.

FIG. 3 is a flow diagram of an example method 300 for improving power management within a processor via an ANN. The steps shown in FIG. 3 may be performed by any suitable computer-executable code and/or computing system, including training system 200 in FIG. 2 and/or variations thereof. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may receive (1) voltage data representative of a measured voltage associated with at least a portion of a processing unit, and (2) electrical current data representative of a measured current associated with the portion of the processing unit, the voltage data and current data both corresponding to a concurrent period of time. For example, receiving module 204 may, as part of training system 200 in FIG. 2, cause training system 200 to receive voltage data 242 and/or current data 244. Receiving module 204 may accomplish these operations in any of the ways described herein.

At step 320, one or more of the systems described herein may train an ANN model to predict an electrical current value based on an input voltage by directing the ANN model to analyze the received voltage data and the received current data in accordance with a training process of the ANN model. For example, training module 206 may, as part of training system 200 in FIG. 2, cause training system 200 to train model 246 to predict an electrical current value based on an input voltage. As will be described in greater detail below in reference to FIG. 6, training module 206 may train model 246 by directing model 246 to analyze the voltage data 242 and current data 244 in accordance with a training process of the ANN model. Training module 206 may accomplish these operations in any of the ways described herein.

At step 330, one or more of the systems described herein may provide the trained ANN model for use in power management of the processing unit. For example, providing module 208 may, as part of training system 200, cause training system 200 to provide model 246 to PMIC 250 for use in power management of a processing unit. Providing module 208 may accomplish these operations in any of the ways described herein.

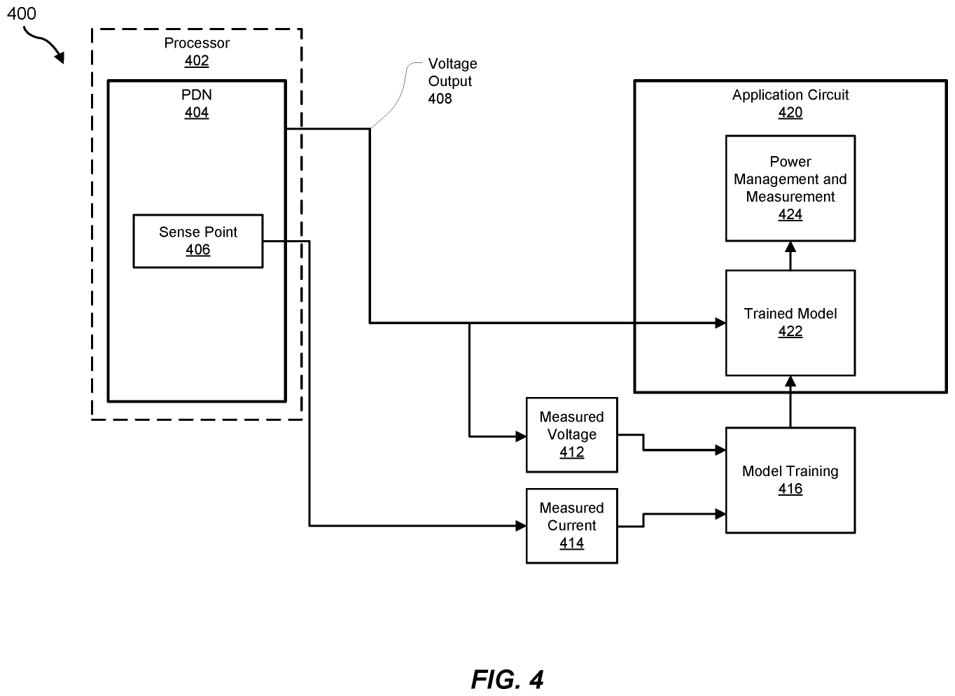

FIG. 4 illustrates a block diagram 400 that shows a system that utilizes an ANN to improve power management within a processor. As shown, a processor 402 is equipped with a PDN 404, which outputs a voltage that is not static but varies to reflect the processor's operational conditions, including waveform variations under different load conditions. This dynamic voltage output 408 serves as an input for both the model training block 416 and the trained model 422 within an application circuit 420.

Within the PDN 404, a sense point 406 is placed to capture the electrical current data, which includes measurements of both steady and transient current flow conditions, such as in response to emulated load changes. This sensing element, part of a data collection interface, is electrically coupled directly to the PDN 404, serving as a dedicated electrical current sensing point. This current data is indicative of various conditions such as current spikes or drops (overshoots and undershoots), load line variations, and the rate of current change (slew rate), as well as how quickly the current stabilizes (settling time). Model training block 416 receives this data and, alongside the voltage output 408 characterized by its waveform data, utilizes it to create a training dataset for an ANN.

Application circuit 420 includes and/or integrates trained model 422, which applies the trained ANN to practical power management tasks. The trained model 422 uses the voltage output 408 as a parameter, interpreting it in the context of the processor's varied electrical behaviors to make informed predictions about power requirements. These predictions inform the power management and measurement block 424, which then tailors power management strategies to the processor's needs.

The power management and measurement block 424 is tasked with translating the predictions from the trained model 422 into actionable power management protocols. It leverages the detailed insight into the processor's dynamic power behavior to optimize energy distribution, adjust operational parameters in response to real-time conditions, and preemptively address potential power-related concerns.

Consequently, the block diagram 400 delineates a refined approach to power management. It leverages an ANN trained on complex voltage and current data, reflecting the dynamic responses of the processor's PDN to various operational conditions. This data includes not only the typical current demands but also extends to cover emulated loads that span the range from minimum to maximum design specifications (e.g., thermal design currents, electrical design currents, duty cycles, pulses at specific frequencies such as between 10 kHz and 100 kHz, etc.), including both DC loads and AC loads. AC loads, in particular, can be represented in the data by their varied amplitudes and frequencies, capturing the full spectrum of the processor's power response capabilities.

In some examples, the voltage data includes waveform data indicative of a dynamic response of a direct-current-to-direct-current converter under a plurality of load conditions. By simulating these conditions, the system prepares the ANN to handle real-world scenarios, ensuring that any processor equipped with the trained model 422 operates with a sophisticated and adaptive energy management solution.

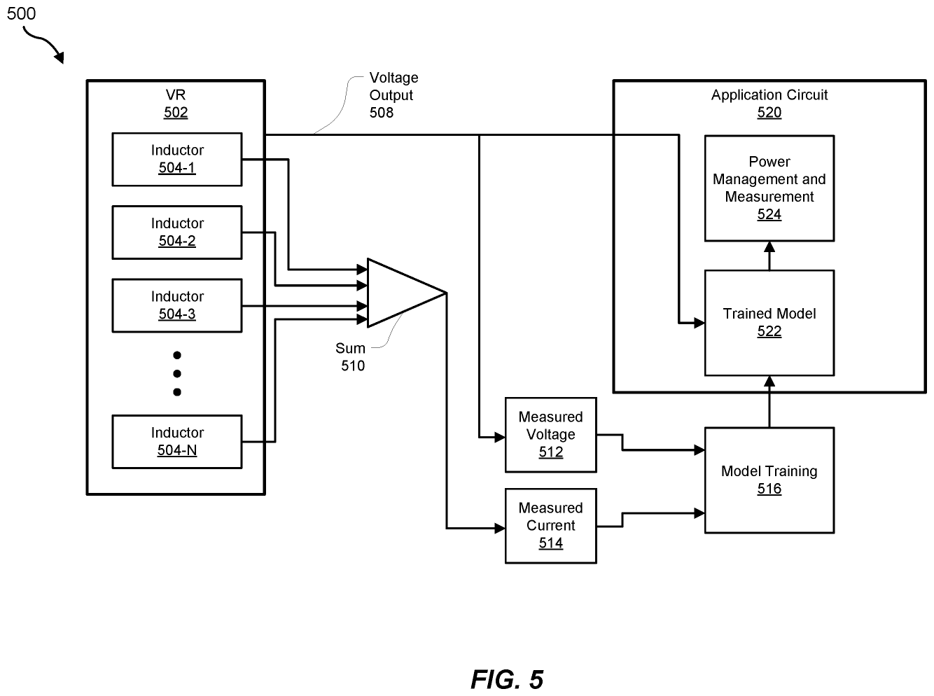

Similar to block diagram 400 in FIG. 4, FIG. 5 provides a block diagram 500 that depicts a system for collecting and processing current data from a Voltage Regulator (VR) 502 within a processor for the purpose of training and using an ANN for power management. The VR 502 is shown to include multiple sensing elements associated with a plurality of inductors 504 (e.g., inductor 504-1, inductor 504-2, inductor 504-3, . . . , inductor 504-N), where each inductor is part of the power network and contributes to the overall current management for the processor.

In operation, current data from each inductor 504 is gathered and then aggregated via a summing operation 510. This aggregated current data provides a comprehensive view of the total current being utilized by the processor at any given time, which can be useful for accurate power management.

The voltage output 508, originating from VR 502, along with the summed current data, is fed into the model training block 516. This block represents the computational and algorithmic resources dedicated to the training of the ANN, which uses the voltage and aggregated current data to learn the power consumption patterns of the processor.

Application circuit 520 includes trained model 522, which is an operational implementation of the ANN post-training. The trained model 522 receives input from voltage output 508 and utilizes the learned patterns to predictively manage power within the processor. The predictions made by the trained model 522 inform the power management and measurement block 524, which then executes power management tasks such as optimizing energy efficiency, managing load demands, and performing real-time adjustments to power delivery.

The power management and measurement block 524 utilizes the insights from the trained model 522 to implement power management strategies. These strategies may include dynamic adjustment of power allocation, improving operational efficiency, and providing real-time monitoring and adjustments to improve processor performance.

Like block diagram 400 in FIG. 4, block diagram 500 in FIG. 5 illustrates a methodical approach to integrating ANN-based modeling into the power management system of a processor. By harnessing detailed current data from multiple inductors within the VR and applying the trained ANN to manage power resources, the system enables a sophisticated and efficient power management solution that can adapt to varying demands and operational conditions.

As mentioned above, in some examples, an ANN may include an RNN. FIG. 6 presents diagram 600, which illustrates the architecture of an RNN configured for processing sequential data input. Diagram 600 includes an example RNN structure that includes multiple layers of interconnected neurons, designed to capture dependencies in time-series data for tasks such as predicting power consumption in a processor's power management system.

As shown in FIG. 6, an RNN includes input 602, which feeds data into the network. This data might represent voltage or current measurements from a processor's PDN and/or inductor current as previously discussed. The input is then processed sequentially through various neuron layers, starting with the first neuron layer 610. Each neuron, such as neurons 610-1 to 610-N, processes the input and passes the information forward through weighted connections, which are adjusted during the training process.

Following the first layer are subsequent layers of neurons, illustrated in FIG. 6 by a second layer 620, containing neurons 620-1 to 620-N, and continuing up to an n-th layer 622. This n-th layer may not be a final layer, but rather represents the scalable nature of RNNs with neurons 622-1 to 622-N. Each layer of the RNN captures more complex patterns and dependencies from the input data, contributing to the network's ability to make precise predictions.

The output of the final neuron layer is directed towards an output 624, which consolidates the network's processed information into a predictive result. In the context of power management, this output could represent a predicted current or voltage level based on historical data patterns and/or essentially concurrently detected current and/or voltage levels.

Part of the training of the RNN includes a backpropagation operation 626. Backpropagation is a mechanism for optimizing the network by adjusting the weights of the neuron connections. Backpropagation works, in some examples, by calculating a gradient of a loss function (i.e., a measure of prediction error) and propagating it back through the network to update weights of the neurons, thereby improving the accuracy of the network over time.

Additionally, neuron dropout operation 628 is depicted in FIG. 6, which operation is a regularization technique used to prevent overfitting in neural networks. Overfitting occurs when a model learns the training data too well, including noise and fluctuations, which might not generalize well to unseen data. Neuron dropout operation 628 can selectively disable a random subset of neurons during training, forcing the network to learn more robust features that are not reliant on any individual neuron.

Diagram 600 shows some elements of an RNN that can be used for dynamic and temporal data processing tasks, such as those that may enable advanced power management systems for processors, where it can be used to predict future states based on past and present data.

During a training process, the RNN, comprised of neurons across multiple layers (e.g., layer 610, layer 620, layer 622, etc.), begins with the initialization of its weight values. These weights, which determine the connections between neurons, can be set to random values to start the learning process. This random initialization can be helpful to facilitate diverse learning pathways and prevent uniform updates during training.

Once initialized, the RNN can process input data through its structure. Input 602 represents the entry point for a sequence of observed voltage and current data points, which serve as the input features for the RNN. As the data flows through the first layer of neurons (e.g., layer 610) and subsequent layers (e.g., layer 620, layer 622, etc.), the RNN generates predictions at output 624. These are the network's estimations of current values based on the input voltage data.

The network's predicted current values are compared to actual measured current values to calculate a loss, which quantifies the prediction error. This prediction error can be useful for learning as it can help guide optimization of the network. Backpropagation operation 626 is then used to propagate the error back through the network and update the weight values. The BPTT algorithm can be specifically designed for RNNs to handle their sequential data structure and temporal dependencies. This algorithm adjusts the weights to minimize the loss, considering the influence of each neuron's activation in the sequence.

This training iteration, consisting of feeding data, generating predictions, calculating loss, and updating weights, is repeated. The weights are adjusted in each iteration until the network's predictions align closely with the actual data, meeting a predetermined convergence criterion. This criterion ensures that the model's accuracy is optimized without overfitting the training data.

After the convergence criterion is met, the RNN undergoes a validation phase with a set of validation data. This phase tests the RNN's generalization capabilities to ensure it can accurately predict outcomes on new, unseen data.

During training iterations, neuron dropout operation 628 may be employed, which can randomly deactivate a selection of neurons. This technique prevents the network from becoming too dependent on any single neuron or pattern found in the training data, promoting a more generalized learning outcome.

The elements depicted in FIG. 6 collectively illustrate methodical training of an RNN for accurate prediction of electrical current values, which variations of the apparatuses, systems, and methods described herein may use for effective power management within processors. The training process ensures the RNN can generalize from the input voltage to predict power requirements dynamically.

As may be clear from the foregoing, the apparatuses, systems, and methods described herein provide many benefits over conventional options for power management. The described apparatuses, systems, and methods provide an improved approach to power management by integrating advanced machine learning techniques with existing power management infrastructure. This integration allows for a more nuanced control over power distribution and management strategies without introducing additional hardware components, thereby maintaining the energy efficiency and design compactness of the processor.

The use of ANNs, specifically RNNs, enables variations of the apparatuses and systems described herein to process sequences of inputs with an internal memory, making them suitable for applications like power management where the temporal sequence of data is significant. The predictive capabilities of these networks facilitate the anticipation of future power requirements, allowing for preemptive adjustments to power usage, which can enhance performance and potentially extend battery life.

Furthermore, by leveraging data already available within the power management system, a need for supplementary sensors or circuits is reduced or eliminated. This not only simplifies the processor's architecture but also reduces or eliminates potential power consumption and other costs associated with extra hardware. Hence, the incorporation of machine learning into power management as described herein is a strategic advancement that aligns with the increasing complexity and operational demands of modern processors.

The term “computer-readable medium,” as used herein, generally refers to any form of device, carrier, or medium capable of storing, carrying, or having encoded thereon computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the examples disclosed herein. This exemplary description is not intended to be exhaustive or to be limited to any precise form disclosed. Many modifications and variations are possible without departing from the spirit and scope of the instant disclosure. The examples disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A power management integrated circuit comprising:
a voltage source electrically coupled to a voltage output of a portion of a processing unit;
a prediction circuit electrically coupled to the voltage source, the prediction circuit comprising an artificial neural network (ANN) model trained to predict an inductor current based on a voltage received via the voltage source;
a management circuit configured to manage power usage of the processing unit based on a predicted inductor current received from the prediction circuit, the predicted inductor current predicted via the ANN model based on the voltage received via the voltage source.

2. The power management integrated circuit of claim 1, wherein:
the ANN model comprises a Recurrent Neural Network (RNN);
the RNN is pre-trained in accordance with an RNN training process comprising:
initializing a plurality of weight values of the RNN with random values;
executing a training iteration comprising:
inputting sequences of observed voltage data points and current data points into the RNN; and
generating predicted current values;
calculating a loss by comparing the predicted current values with actual measured current values; and
updating at least one of the plurality weight values using backpropagation through time and an optimization algorithm;
repeating the training iteration until a predetermined convergence criterion is met; and
validating the RNN with a set of validation data.

3. The power management integrated circuit of claim 1, wherein the processing unit comprises at least one of:
a central processing unit (CPU);
a graphics processing unit (GPU);
a tensor processing unit (TPU); or
an accelerated processing unit.

4. The power management integrated circuit of claim 3, wherein the ANN model is incorporated into an artificial intelligence core of the processing unit.

5. A method comprising:
receiving:
voltage data representative of a measured voltage associated with at least a portion of a processing unit;
electrical current data representative of a measured current associated with the portion of the processing unit, the voltage data and current data both corresponding to a concurrent period of time;
training an artificial neural network (ANN) model to predict an electrical current value based on an input voltage by directing the ANN model to analyze the received voltage data and the received current data in accordance with a training process of the ANN model; and
providing the trained ANN model for use in power management of the processing unit.

6. The method of claim 5, wherein the ANN model comprises a Recurrent Neural Network (RNN).

7. The method of claim 6, wherein:
the RNN comprises a plurality of weight values; and
the training process of the ANN model comprises:
initializing the plurality of weight values of the RNN with random values;
executing a training iteration comprising:
inputting a sequence of voltage data points and current data points into the RNN;
generating predicted current values;
calculating a loss by comparing predicted values with measured current values; and
updating at least one of the plurality of weight values using backpropagation through time (BPTT) and an optimization algorithm;
repeating the training iteration until a predetermined convergence criterion is met; and
validating the RNN with a set of validation data.

8. The method of claim 5, wherein the processing unit comprises a graphics processing unit (GPU).

9. The method of claim 8, wherein providing the trained ANN model for use in power management of the processing unit comprises incorporating the trained ANN model into an artificial intelligence core of the GPU.

10. The method of claim 5, wherein the voltage data comprises waveform data indicative of a dynamic response of a direct-current-to-direct-current converter under a plurality of load conditions.

11. The method of claim 5, wherein training the ANN model comprises analyzing voltage waveform data that reflects dynamic voltage regulator responses due to emulated current loads on a power distribution network (PDN), the dynamic voltage regulator responses comprising at least one of:
a voltage overshoot;
a voltage undershoot;
a voltage load line;
a voltage slew rate; and
a settling time.

12. The method of claim 11, wherein the emulated current loads comprise at least one of:
a direct current (DC) load with amplitudes ranging between a minimum and a maximum of a thermal design current of the processing unit; and
an alternating current (AC) load with amplitudes ranging between a minimum and a maximum of an electrical design current of the processing unit.

13. The method of claim 12, wherein:
the emulated current loads comprise the AC load with amplitudes ranging between the minimum and the maximum of the electrical design current of the processing unit; and
the AC current load is emulated with pulses at frequencies between 10 kilohertz (kHz) and 100 kHz.

14. The method of claim 12, wherein:
the emulated current loads comprise the AC load with amplitudes ranging between the minimum and the maximum of the electrical design current of the processing unit; and
the AC current load is emulated with duty cycles that vary to simulate different operational conditions of the processing unit.

15. The method of claim 5, further comprising collecting the electrical current data via at least one sensing element electrically coupled to a power delivery network (PDN) included in the processing unit.

16. The method of claim 5, further comprising collecting the electrical current data by aggregating a plurality of electrical current data sources collected via a plurality of sensing elements electrically coupled to a plurality of inductors included in the processing unit.

17. The method of claim 5, further comprising providing the trained ANN model for use in power management of an additional processing unit.

18. A system comprising:
at least one processor;
at least one storage medium having encoded thereon executable instructions that, when executed by the at least one processor, cause the at least one processor to carry out a method, the method comprising:
receiving:
voltage data representative of a measured voltage associated with at least a portion of a processing unit; and
electrical current data representative of a measured current associated with the portion of the processing unit, wherein the voltage data and current data correspond to a concurrent period of time;
training an artificial neural network (ANN) model to predict an electrical current value based on input voltage data by analyzing the received voltage data and the received current data; and
providing the ANN model for use in power management of an additional processing unit.

19. The system of claim 18, wherein:
the ANN model is a Recurrent Neural Network (RNN); and
training the ANN model comprises:
initializing a plurality of weight values of the RNN with random values;
executing a training iteration comprising:
inputting sequences of voltage data points and current data points into the RNN;
generating predicted current values;
calculating a loss by comparing the predicted values with actual measured current values; and
updating at least one of the weight values using backpropagation through time and an optimization algorithm;
repeating the training iteration until a predetermined convergence criterion is met; and
validating the RNN with a set of validation data.

20. The system of claim 18, further comprising a data collection interface that includes at least one sensing element electrically coupled to an electrical current sensing point included in the processing unit for collecting the current data.
